(19) United States
(12) Patent Application Publication
(10) Pub. No.: US 2008/0154809 A1
(43) Pub. Date: Jun. 26, 2008

(54) Use and construction of categorical interactions using a rule gene in a predictive model

(75) Inventors: Frank W. Stockwell, Newburyport, MA (US); Matthew V. Grieco, Somerville, MA (US)

Correspondence Address: BACHMAN & LAPOINTE, P.C., 900 CHAPEL STREET, SUITE 1201, NEW HAVEN, CT, 06510, US

(73) Assignee: Genalytics, Inc.

(21) Appl. No.: 11/584,325

(22) Filed: Oct. 20, 2006

(51) Int. Cl. G06N 3/12

(52) U.S. Cl. 706/13

(57) ABSTRACT

A gene is disclosed for use in a predictive genetic algorithm that performs categorical interactions between dataset variables. The categorical logic that performs the interaction is encoded as a binary string.

### BACKGROUND OF THE INVENTION

The invention relates generally to the field of genetic algorithms. More specifically, the invention relates to methods for implementing categorical interactions in chromosomes using rule genes.

Genetic algorithms are useful in solving optimization problems, scheduling problems and function-approximation problems and are currently used in chemistry, medicine, computer science, economics, physics, engineering design, manufacturing systems, electronics and telecommunications and various related fields. Custom computer applications are now commonplace in a wide variety of fields, and are in use by a majority of Fortune 500 companies to solve difficult scheduling, data fitting, trend spotting and budgeting problems, prediction, and virtually any other type of combinatorial optimization problem.

Genetic algorithms are stochastic search algorithms that use techniques inspired by evolutionary biology such as inheritance, mutation, selection, and crossover which is also known as recombination. A typical genetic algorithm requires a genetic representation of solutions and a fitness function to evaluate them.

Genetic algorithms are based on the same principle as that of natural evolution. Members of a population in artificial evolution represent the candidate solutions. The problem itself represents the environment. Every candidate solution is applied to the problem and a fitness value is assigned for every candidate solution depending upon the performance of the candidate solution on the problem. In compliance with the theory of natural evolution, more adaptive or fitter hereditary traits are carried over to the next generation. The features of natural evolution are maintained by ensuring that the reproduction process preserves many of the traits of the parent solution and yet allows for diversity for exploration of other traits. The fitness of a candidate is measured by the success of the candidate's life.

Genetic algorithms operate on a set of candidate solutions which are generated randomly or probabilistically at the beginning of evolution. This set of candidate solutions are generally bit streams called chromosomes as shown in FIG. 1. The set of current chromosomes is termed a population. Genetic algorithms operate iteratively on a population of chromosomes, updating the pool of chromosomes at every epoch or iteration. For each epoch, all the chromosomes are evaluated according to the fitness function and ranked according to their fitness values. The fitness function is used to evaluate the potential of each candidate solution. The chromosomes with higher fitness values have higher probability of containing more adaptive traits than the chromosomes with lesser fitness values, and are more fit to survive and reproduce. A new population is then generated by probabilistically selecting the most fit individuals from the current population using a selection operator. Some of the selected individuals may be carried forward into the next generation intact to prevent the loss of the current best solution. Other selected chromosomes are used for creating new offspring individuals by applying genetic operators such as crossover and mutation. The end result of this process is a collection of candidate solutions which contain members that are often better than the previous generations.

In order to apply a genetic algorithm to a particular search, optimization, or function approximation problem, the problem must be first described in a manner such that an individual will represent a potential solution and a fitness function which evaluates the quality of the candidate solution must be provided. The initial potential solutions (population) are generated randomly and then the genetic algorithm makes this population more adaptive by means of selection, recombination and mutation as shown in FIG. 2. FIG. 2 shows a simple genetic algorithm framework which may be applied to most search, optimization and function approximation problems with slight modifications depending upon the problem environment. The inputs to the genetic algorithm specify the population size to be maintained, the number of iterations to be performed, a threshold value defining an acceptable level of fitness for terminating the algorithm, and the parameters to determine successor populations.

To apply genetic algorithms to any problem, the candidate solutions must be encoded in a suitable form so that genetic operators are able to operate in an appropriate manner. Generally, the potential solution of the problem is represented as a set of parameters encoded as chromosomes. As shown in FIG. 1, solutions are represented in binary as strings of 1's and 0's, but different encodings are also possible. Each bit in the string can represent some characteristic of the solution.

Binary encodings are used due to their simplicity and ease with which the genetic crossover and mutation operators can manipulate the binary encoded bit streams. Integer and decision variables are easily represented in binary encoding. Discrete variables can also be easily encoded as bit strings. The easiest way to encode any feature into a bit stream is to use a bit string of length N, where N is the number of possible values a particular feature or gene may have.

Continuous values are harder to encode into binary strings. In some cases continuous values are discretized by classifying the values into classes. In some cases continuous values are encoded directly into binary strings by converting the number into a binary format. However, to maintain fixed length strings, the precision of continuous values is restricted.

Binary encodings are used in feature subset selection tasks. In a feature subset selection task, the aim is to find an optimal combination of subset of features from a set of candidate features. A binary encoding can be used to represent the subset of features. The chromosome is a binary string of length equal to the number of candidate features. A 0 in bit position n in the chromosome represents that the corresponding feature is not included in the subset of features, whereas a 1 in bit position n represents that the corresponding feature is included in the subset of features.

The standard representation is an array of bits. Arrays of other types and structures may be used in essentially the same way. The main property that makes these genetic representations convenient is that their parts are easily aligned due to their fixed size that facilitates simple crossover operation. Variable length representations may also be used, but crossover implementation is more complex.

The simplest algorithm represents each chromosome as a bit string. Typically, numeric parameters can be represented by integers, though it is possible to use flointing point representations. The basic algorithm performs crossover and mutation at the bit level. Other variants treat the chromosome as a list of numbers which are indexes into an instruction table, nodes in a linked list, hashes, objects, or any other imaginable data structure. Crossover and mutation are performed so as to respect data element boundaries. For most data types, specific variation operators can be designed. Different chromosomal data types seem to work better or worse for different specific problem domains.

The fitness function ƒ(x) is defined over the genetic representation and measures the quality of the represented solution. The fitness function is always problem dependent. Once the genetic representation and the fitness function is defined, the algorithm proceeds to initialize a population of solutions randomly, then improves it through repetitive applications of mutation, crossover, and selection operators.

The population size depends on the nature of the problem, but typically contains several hundreds or thousands of possible solutions. Traditionally, the population is generated randomly, covering the entire range of possible solutions known as the search space.

During each successive epoch, a proportion of the existing population is selected to breed a new generation (steps 205-215). Individual solutions are selected through a fitness-based process, where fitter solutions as measured by the fitness function ƒ(x) are more likely to be selected. The fitness function ƒ(x) is specific to a problem domain and varies from implementation to implementation. For example, in any classification task, the fitness function typically has a component that scores the classification accuracy of the rule over a set of provided training examples. The value assigned by the fitness function also influences the number of times an individual chromosome is selected for reproduction. The candidate solutions are evaluated and ranked in descending order of their fitness values. The solutions with higher fitness values are superior in quality and have more chances of surviving and reproducing.

A fitness function ƒ(x) quantifies the optimality of a solution. It evaluates all the candidate solutions and evaluates the quality of all individual solutions. It gives a criterion to rank candidate solutions which is the basis of making a decision as to whether a particular individual solution is fit to survive and reproduce. A fitness function ƒ(x) must be devised for each problem. The fitness function takes in one chromosome at a time as input and returns a single numeric value, which is indicative of the ability or utility of the candidate solution represented by the input chromosome. The fitness function ƒ(x) should be smooth and regular so that there is not much disparity in the fitness values of chromosomes. An ideal fitness function ƒ(x) should neither have too many local maxima, nor a very isolated global maximum. The fitness function should correlate closely with the algorithm's goal, and should be executed quickly, as genetic algorithms must be iterated numerous times to produce useful results. For example, if the task is to learn classification rules, then the function has a component that scores the classification accuracy of the rule over a set of training examples.

After the candidate solutions are ranked, the next step is to generate a second generation population of solutions. The selection process selects some of the top solutions probabilistically (step 220). A certain number of chromosomes from the current population are selected for inclusion in the next generation. Even though these chromosomes are included directly in the next generation, they are also used for recombination to achieve preservation of the adaptive traits of the parent chromosomes and also allow exploration of other traits. Once these members of the current generation have been selected for inclusion in the next generation population, additional members are generated using a crossover operator (step 225).

For each new solution to be produced, a pair of parent solutions is selected for breeding from the pool selected previously. By producing an offspring solution using crossover and mutation, a new solution is created which shares many of the characteristics of its parents. New parents are selected for each child, and the process continues until a new population of solutions of appropriate size is generated.

Various crossover operators may be used. An example is shown in FIG. 3. The crossover operator produces two new offspring from two parent strings by copying selected bits from each parent. The bit at position i in each offspring is copied from the bit at position i in one of the two parents. The choice of which parent contributes the bit for position i may be determined by an additional string called a crossover mask. After crossover, genetic algorithms often apply a mutation operator to the chromosomes to increase diversity (step 230). An example mutation is shown in FIG. 4. Mutation is intended to prevent early convergence of all solutions in the population into a local optimum of the solved problem. The mutation operator produces small random changes to the bit string by choosing a single bit at random, then changing its value as shown in FIG. 4.

The combined process of selection, crossover and mutation produces a new population generation (step 235). The current generation population is replaced by the newly generated population. Some individuals may be carried over. The new population becomes the current generation population in the next iteration (steps 220-240). These processes ultimately result in the next generation population of chromosomes that is different from the initial generation. Generally the average fitness will have increased by this procedure for the population, since only the best organisms from the first generation are selected for breeding, along with a small proportion of less fit solutions, for reasons already mentioned above. So, a random population generation is required only once, at the start of first generation, and otherwise the population generated in the n^{th} generation becomes the starting population for the (n+1)^{th} generation. The genetic algorithm process terminates at a specified number of iterations, or if the fitness value crosses a specified threshold fitness value (step 245). The outcome of a genetic algorithm is a set of solutions that have a fitness value significantly higher than the initial random population (step 250).

This generational process is repeated until a termination condition has been reached. Common terminating conditions are a solution is found that satisfies a minimum criteria, a fixed number of generations are reached, an allocated budget (computation time/money) is reached, or the highest ranking solution's fitness is reaching or has reached a plateau such that successive iterations no longer produce better results.

There is no guarantee that the solution obtained by a genetic algorithm is optimal, however, genetic algorithms will usually converge to a solution that is very good.

Since genetic algorithms are stochastic, iterative algorithms, the candidate solutions should get better with more iterations. Genetic algorithms attempt to preserve individuals with good traits (i.e., preserving individuals having high fitness values) and to create better individuals with new traits by combining fit individuals. Genetic algorithms employ genetic operators to preserve fit individuals (selection) and to explore new traits by recombining fit individuals (crossover and mutation). The function of a genetic operator is to cause chromosomes created during reproduction to differ from those of their parents in order to explore any missing traits. The recombination operators must be able to create new configurations of genes that never existed before and are likely to perform well.

At every iteration, chromosomes are recombined to create new chromosomes in an attempt to find better chromosomes. As genetic algorithms follow the theory of natural evolution, better individuals should be able to survive and reproduce. The selection operator is used to select fit individuals from the population for recombination. Before any recombination takes place, the fittest individual solutions are selected and promoted to the next generation in an attempt to ensure that the best solution is not lost. Then the selection operator is applied again for choosing chromosomes to act as parents and produce new offspring. The selection operator is solely responsible for choosing better individuals for preservation and recombination. The selection process is one of the key factors affecting the overall performance of the genetic algorithms. If the selection mechanism selects fit individuals for elitism and recombination, then the solution converges faster. The selection process controls which fit individuals should be preserved and which individuals should be used for recombination. A bad selection mechanism could hamper the performance of a genetic algorithm in terms of quality and also in terms of convergence rate.

Once a basic genetic algorithm is implemented, a new chromosome may be created to solve another problem. The same encoding may be used with only the fitness function changed. However, for some problems, the choosing and implementation of the encoding and the fitness function may be difficult.

Predictive modeling is the process by which a model, or equation, is created to best predict an outcome. Current methods of creating a predictive model include linear regression, logistic regression, and neural networks.

The input to all methods of creating a model is a dataset. A training dataset is used to build a predictive model and contains several independent variables and a single dependent variable. The independent variables are used in the body of the equation to predict the dependent variable. The goal in building a predictive model is to create an equation that maximizes the ability of correctly predicting the dependent variable in the training dataset using a subset of the independent variables in the training dataset.

Several tasks that must be performed when creating a predictive model include selecting a subset of the independent variables to use in the equation, determining the treatment of the variables used (i.e. missing value substitution, normalization, outlier trimming, and others), and searching for interactions between two independent variables. Discovering linear relationships between independent variables that are helpful in predicting an outcome is relatively easy when compared to discovering nonlinear or temporal relationships between variables.

An example of a nonlinear relationship would be exploring the effect of interacting categories, such as AGE=52 & INCOME>55,000, of two independent variables on predicting an outcome. Since there are many possible interactions to explore using a genetic algorithm as a tool, better results may be obtained faster than using other methods.

Consequently, a need exists for a methodology to encode a categorical interaction between two variables in a predictive model so it can be evolved using a genetic algorithm.

### SUMMARY OF THE INVENTION

Although there are various types of chromosomes capturing problem encoding, such chromosomes are not completely satisfactory. The inventors have discovered that it would be desirable to include genes that perform categorical interactions between dataset variables. The categorical logic that performs the interaction is encoded as a binary string.

One aspect of the invention is a rule gene for use in a chromosome of a genetic algorithm. Rule genes according to this aspect of the invention comprise at least one variable selection component for determining which variables from a dataset will interact, at least one category selection component for determining which categories from the dataset will interact, and at least two coefficient genes, wherein the quantity of variable selection components, category selection components, and coefficient genes that comprise the rule gene is defined as n:n:2ⁿ, respectively, where n≧1, and wherein one of the coefficient genes provides a result from an interaction between the selected variable and selected category.

Another aspect of the invention is a method of creating categorical interactions for use in a genetic algorithm as a rule gene. Methods according to this aspect begin with providing at least one variable selection component for determining which variables from a dataset will interact, providing at least one category selection component for determining which categories from the dataset will interact, and providing at least two coefficient genes, wherein the quantity of variable selection components, category selection components, and coefficient genes that comprise the rule gene is defined as n:n:2ⁿ, respectively, where n≧1, and wherein one of the coefficient genes provides a result from an interaction between the selected variable and the selected category.

Yet another aspect of the invention is a method of creating categorical interactions for use in a genetic algorithm as a rule gene. Methods according to this aspect begin with providing a first and a second variable selection component for determining which variables from a dataset will interact, providing a first and a second category selection component for determining which categories from the dataset will interact, providing a first, a second, a third and a fourth coefficient gene, wherein one of the coefficient genes provides a result from an interaction between corresponding selected variables and selected categories further comprising choosing the first coefficient gene as the result if a variable selected by the first variable selection component has a value that is selected by the first category selection component and if a variable selected by the second variable selection component has a value that is selected by the second category selection component, choosing the second coefficient gene as the result if a variable selected by the first variable selection component has a value that is selected by the first category selection component and if a variable selected by the second variable selection component has a value that is not selected by the second category selection component, choosing the third coefficient gene as the result if a variable selected by the second variable selection component has a value that is selected by the second category selection component and if a variable selected by the first variable selection component has a value that is not selected by the first category selection component, and choosing the fourth coefficient gene as the result if a variable selected by the first variable selection component has a value that is not selected by the first category selection component, and if a variable selected by the second variable selection component has a value that is not selected by the second category selection component.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary architecture of two parent chromosomes.

FIG. 2 is an exemplary block diagram of a method for a genetic algorithm.

FIG. 3 is an exemplary crossover of the two parent chromosomes shown in FIG. 1.

FIG. 4 is an exemplary mutation of the two offspring chromosomes shown in FIG. 3.

FIG. 5 is an exemplary architecture of a rule gene according to the invention.

FIG. 6 is an exemplary architecture of a category selection component according to the invention.

FIG. 7 is another exemplary category selection component according to the invention.

FIG. 8 is an exemplary architecture of a variable selection component according to the invention.

FIG. 9 is an exemplary architecture of a coefficient gene according to the invention.

FIG. 10 is an exemplary block diagram of a method showing the functionality of the rule gene according to the invention.

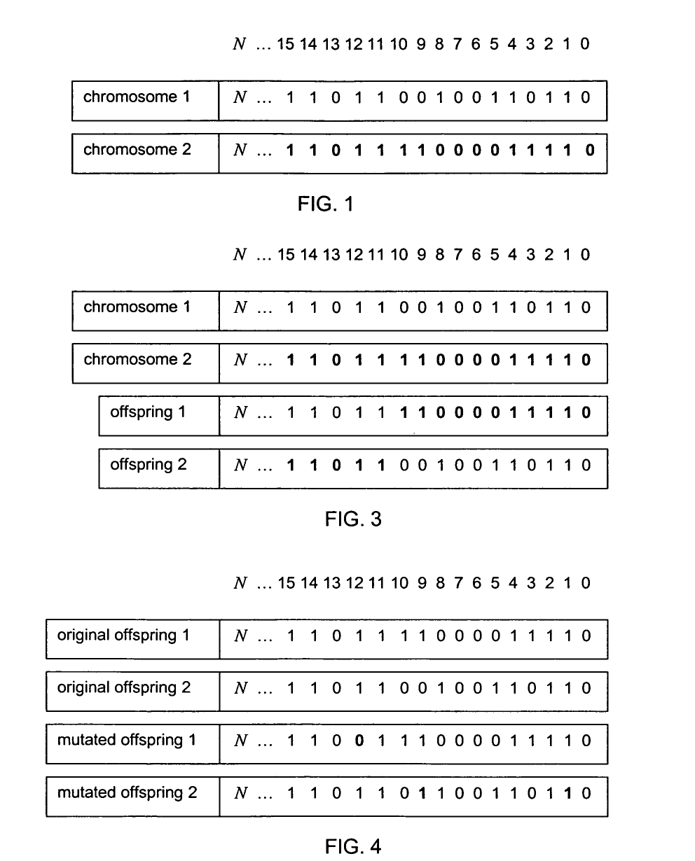

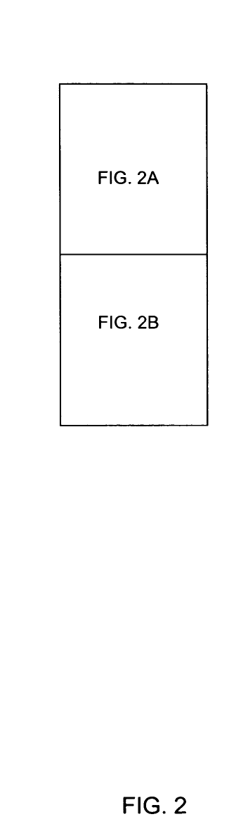

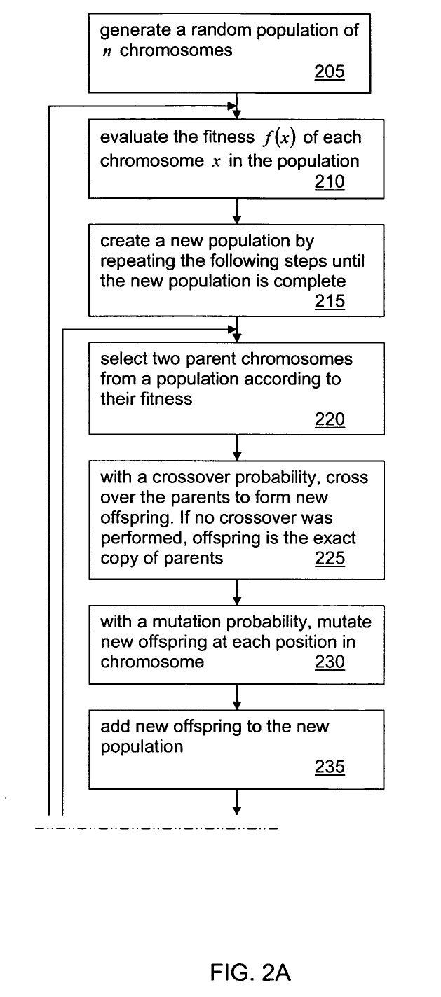

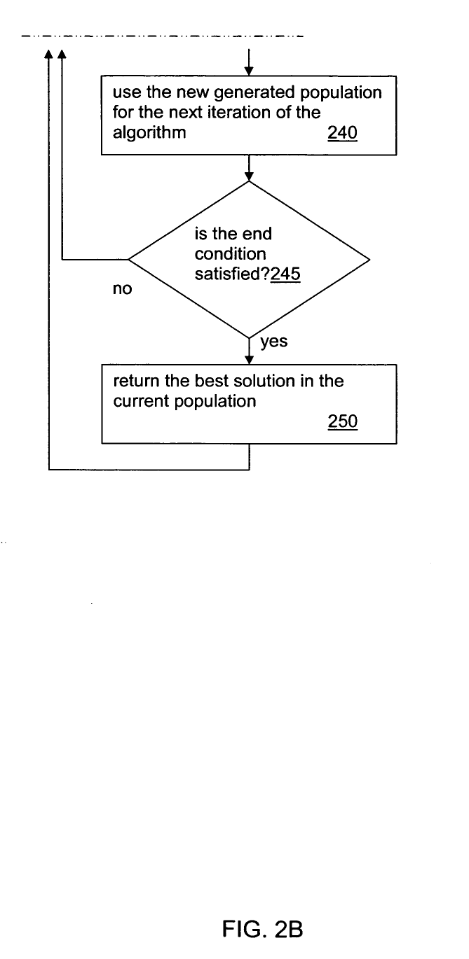

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The invention is not limited to any particular software language described or implied in the figures. The preferred language is JAVA. However, a variety of alternative software languages may be used for implementation of the invention.

For business purposes, a genetic algorithm is implemented and predictive models are encoded into chromosomes that may be manipulated by the genetic algorithm and back to a predictive model. The predictive model may be thought of as the equation for the genetic algorithm, and the genetic algorithm evolves the equation. Embodiments of the invention provide a rule gene for use in genetic algorithm business applications.

Genes represent discrete components of a problem solution (chromosome) that can vary independently of each other throughout the evolution process. A gene can be defined as the encoding of a single parameter in a genetic algorithm and may take many forms depending on the problem definition.

The genetic algorithm encoding process uses a set of genes grouped together forming a chromosome to describe a predictive model. Each gene describes a piece of the predictive model and appears as a binary bit string that may be decoded and encoded during an evolution epoch. Genes are typically represented as sequences of 1's and 0's which introduces a layer of complexity as a translation is needed between the actual values of parameters, for example, decimal numbers representing values and categories such as age, and their binary equivalent.

Configuring genes as objects in Java makes the implementation more intuitive and may be extended to make them reusable across different genetic algorithm implementations. Each object may be viewed as an independent machine with a distinct function. Objects act on each other, as opposed to a traditional view in which a program may be seen as a collection of functions, or simply as a list of computer instructions. Each object is capable of receiving data, processing data, and sending data to other objects.

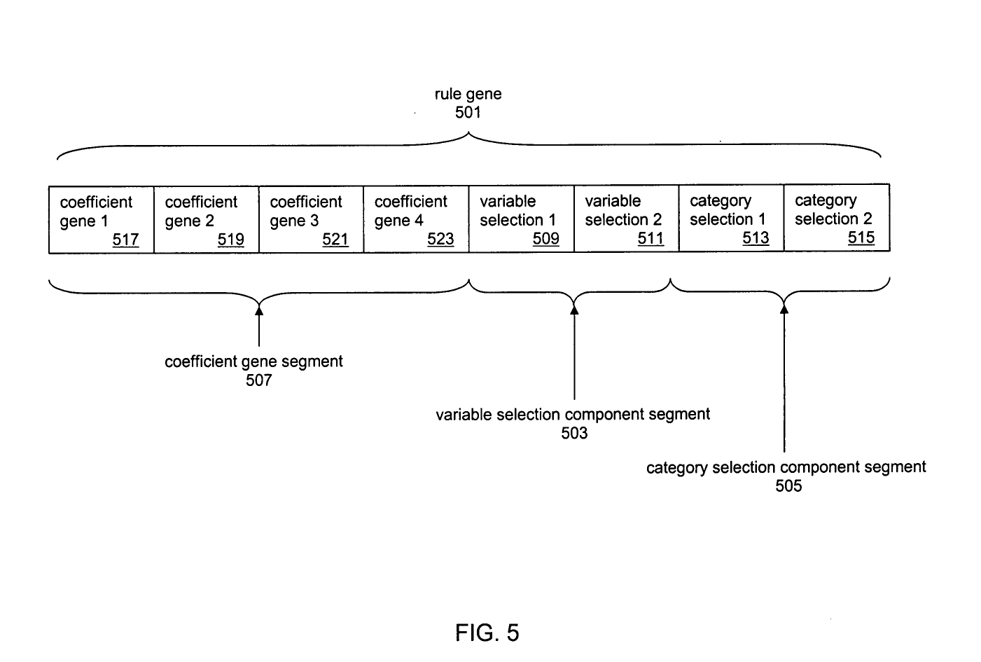

Shown in FIG. 5 is the architecture of a rule gene 501 according to the invention. The purpose of the rule gene 501 is to encode categorical logic as a binary string within a chromosome and implement categorical interactions found in predictive models. A chromosome containing a rule gene 501 may be evolved like other chromosomes in the genetic algorithm. The rule gene 501 describes a segment of the whole predictive model, and using categorical interactions, improves the performance of the predictive model.

The rule gene 501 includes at least one variable selection component segment 503 that comprises at least one variable selection component, at least one category selection component segment 505 that comprises at least one category selection component and a coefficient gene segment 507 that comprises at least two coefficient genes. The relationship,

n:n:2ⁿ where n≧1, (1)

defines the quantity of variable selection components 503, category selection components 505, and coefficient genes 507, respectively, that comprise a rule gene 501. The exemplary embodiment 501 shown in FIG. 5 employs two variable selection components, component 1 509 and component 2 511, two category selection components, component 1 513 and component 2 515, and four coefficient genes, gene 1 517, gene 2 519, gene 3 521 and gene 4 523 in accordance with (1).

A variable selection component 509, 511 determines which variables from the dataset will interact. The variable selection component 509, 511 may be an integer value where the value selects a variable. Every variable in the dataset is assigned a unique identification number. The variable selection component 509, 511 value points, or maps to a corresponding variable in the dataset that is used in the interaction.

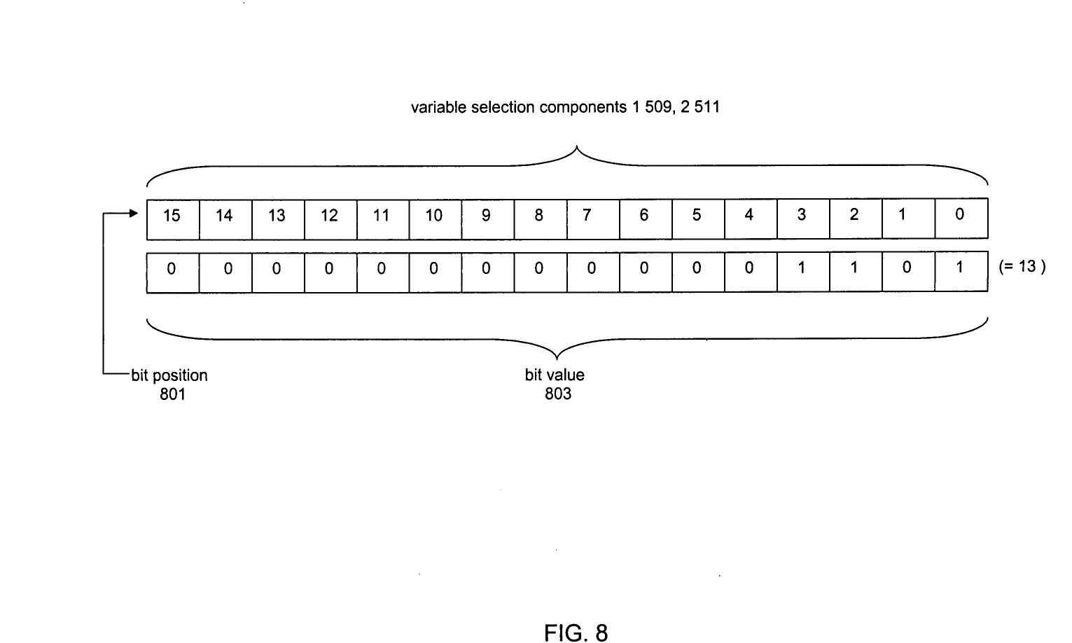

Shown in FIG. 8 is the architecture of a variable selection component. A variable selection component 509, 511 may, for example, be an integer value of 13 which maps to the thirteenth variable of the dataset. In the exemplary dataset, the thirteenth variable is AGE which is the value of variable selection component 1 509. The integer value 801, 803 used for variable selection is converted to a 16-bit binary string prior to evolution using standard binary conversion. For example, 13 equals the binary string 0000000000001101. The variable selection component 2 511 value maps to GENDER in the exemplary dataset. The variable selection components 1 509 and 2 511 may be randomly initialized and may change as the chromosome undergoes evolution.

Category selection components 1 513 and 2 515 determine which categories within its assigned variables are interacting. For example, the rule gene 501 may interact AGE variable values with GENDER variable values. The exemplary embodiment interacts two categories, however, as (1) shows, depending on the architecture and application of the rule gene 501, a plurality of same or different categories may interact.

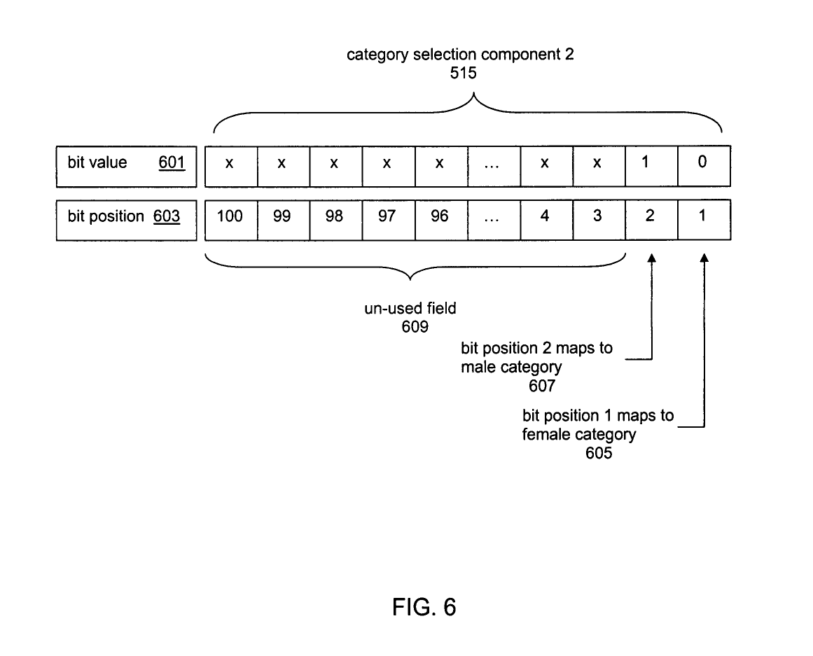

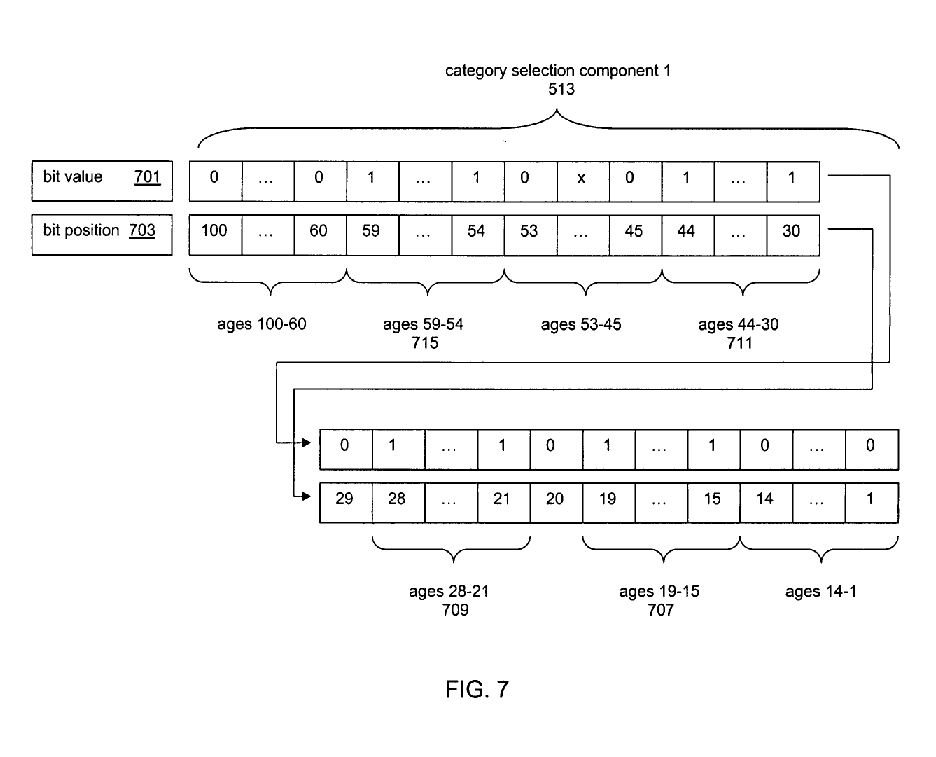

In the exemplary embodiment, each category selection component 1 513 and 2 515 is represented as a 100-bit binary string. For continuous variables, such as category selection component 1 513 shown in FIG. 7, each bit maps to a distinct age and groups of bits represent a range of age input values. Each bit may represent a distinct category. For example, category selection component 2 515 is shown in FIG. 6 and may choose between two categories, male/female.

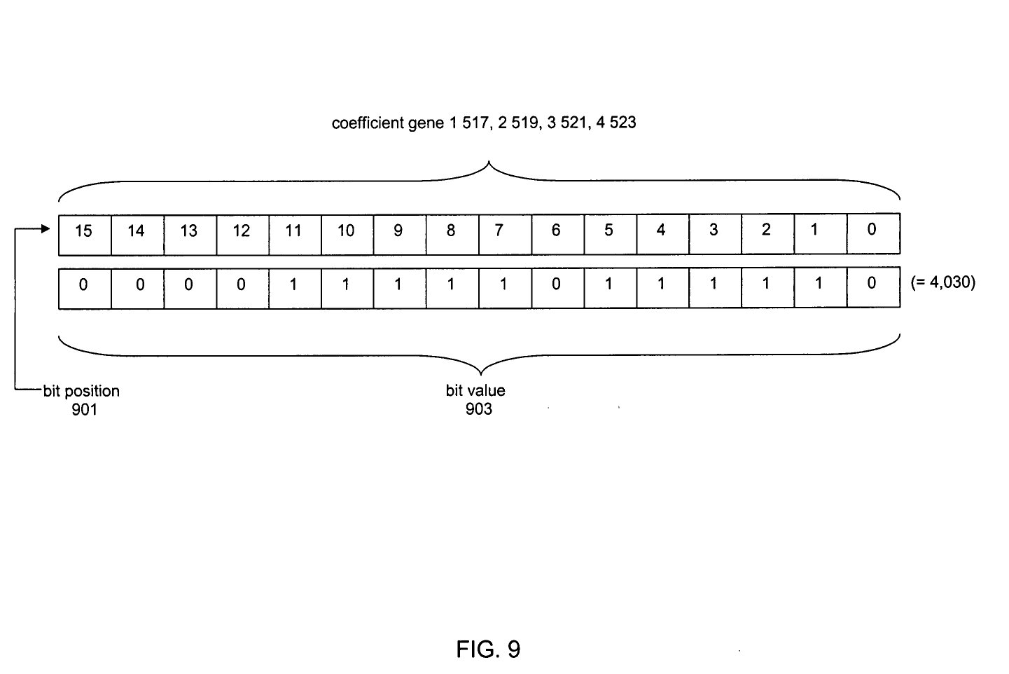

Coefficient genes 1 517, 2 519, 3 521 and 4 523 are logical objects like other genes and have a state and logic that may manipulate their state. State refers to the value that it contains, similar to how variable selection component 2 515 has a value of 13 during an epoch of the GA execution. Logic refers to the process by which a gene is encoded into a binary string prior to evolution and after evolution, decoded to an integer value. Logic may also apply to the internal logic of the gene in describing how it is applied. The coefficient gene architecture is shown in FIG. 9. Coefficient genes 517, 519, 521, 523 may store a value that is used as a multiplier for another value, or may store an output of another gene. In the exemplary rule gene 501, coefficient genes 1 517, 2 519, 3 521 and 4 523 are used to store four outputs. As to which coefficient value is returned is determined by applying the categorical interaction logical operators of the rule gene 501 object to the result of the variable 503 and category 505 selection component segments. The logic is defined in the rule gene 501 object and does not change during evolution. What may change are the values of category selection components 1 513 and 2 515, variable selection components 1 509 and 2 511, and coefficient genes 1 517, 2 519, 3 521, and 4 523. Evolution may affect which variable is returned when applying the rule gene 501 to a specific observation in the modeling dataset.

Coefficient genes have an associated mutate method which alters its state as part of the evolutionary process. Rule genes 501 also have an associated mutate method. The rule gene 501 mutating method summons the mutate method of each of the coefficient genes 1 517, 2 519, 3 521 and 4 523 in addition to mutating the variable 1 509 and 2 511 and category selection 1 513 and 2 515 components.

When a rule gene is applied to an observation in a dataset, one of the four coefficient genes value is returned. The logic to determine which coefficient gene value is returned is the rule gene 501 object.

The rule gene 501 logic may be summarized as: if the variable selected by the first variable selection component 1 509 has a value that is selected in the first category selection component 1 513, and if the variable selected by the second variable selection component 2 511 has a value that is selected in the second category selection component 2 515, the first coefficient 1 517 is returned. Or, if the variable selected by the first variable selection component 1 509 has a value that is selected in the first category selection component 1 513, and if the variable selected by the second variable selection component 2 511 has a value that is not selected in the second category selection component 2 515, then the second coefficient 2 519 is returned. Or, if the variable selected by the second variable selection component 2 511 has a value that is selected in the second category selection component 2 515, and if the variable selected by the first variable selection component 1 509 has a value that is not selected in the first category selection component 1 513, then the third coefficient 3 521 is returned. Or, if the variable selected in the first variable selection component 1 509 has a value that is not selected in the first category selection component 1 513, and if the variable selected in the second variable selection component 2 511 has a value that is not selected in the second category selection component 2 515, then the fourth coefficient 4 523 is returned.

The described logic is representative of n in (1) equaling 2. However, as n increases, the number of logical comparisons increases accordingly. For n=3, the number of logical comparisons would equal eight, following the above similar to that of a logic table.

The coefficient genes 1 517, 2 519, 3 521 and 4 523 used in the exemplary embodiment use a 16-bit integer. Other integer values requiring more than 16-bits may be employed. The 16-bit integer 901, 903 has a minimum value of −2¹⁵ (−32,768) and a maximum value of 2¹⁵−1 (32,767). Bits 14-0 are used to store the value of the number and bit 15 is used to indicate sign (±). Prior to evolution, the integer value, for example 4,030, is converted into a 16-bit binary string 0000111110111110. When a coefficient gene is used in an equation, the value of the 16-bit integer is divided by 2¹⁵−1, returning a value between −1 and 1. This operation normalizes the coefficient value between −1 and 1. However, any range between −32,768 and 32,767 may be specified.

Coefficient genes 1 517, 2 519, 3 521 and 4 523 may store multipliers or outputs for observed variables described by the variable selection components 1 509 and 2 511.

Genes work together in groups to perform a large part of a predictive model. For example, one such gene, an include/exclude gene (not shown) is responsible to determine if a specific variable treatment or interaction should be used in the model. If this gene is included, other genes manipulate the data. An include/exclude gene may mark a rule gene as an active part of the predictive model.

The rule gene 501 allows ranges of variables (category selection component 1 513) or individual categories (category selection component 2 515) to interact with other genes of a chromosome. For example, category selection component 2 515 shown in FIG. 6 contains a GENDER variable and has values of F 605 for female indicated by a bit value 601 of 0 located in bit position 603 1, or an M 607 for male indicated by a bit value 601 of 1 located in bit position 603 2. Category selection component 2 515 shown in FIG. 7 contains an AGE continuous variable between 0 and 100 with a median of 50. The purpose of a genetic algorithm is to try combinations of categories that yield higher response rates. This activity isolates a segment of the population as being more likely to respond than other segments.

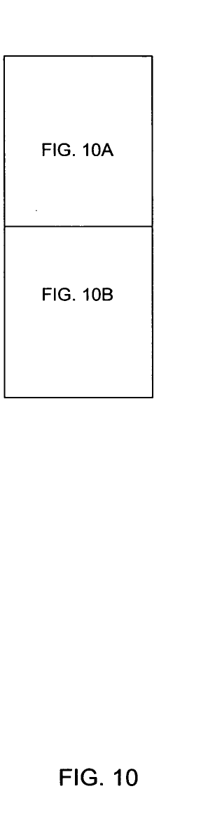

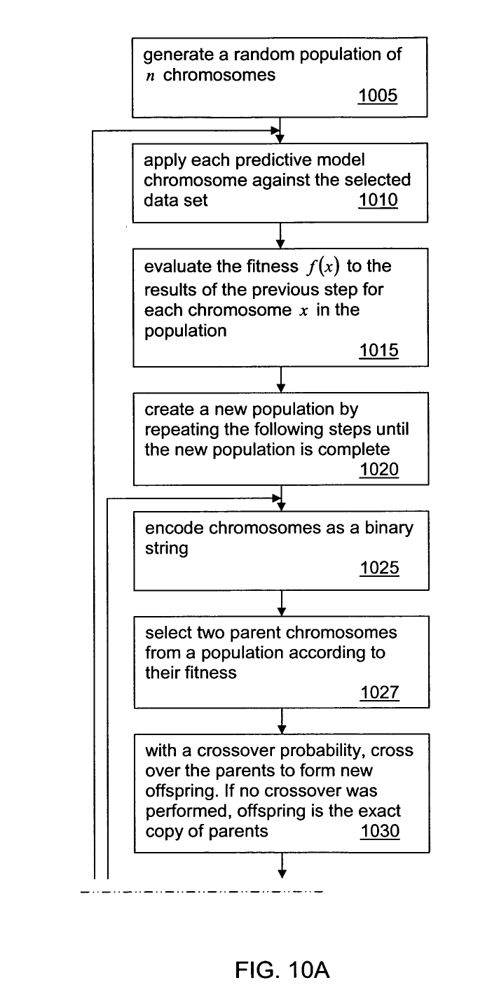

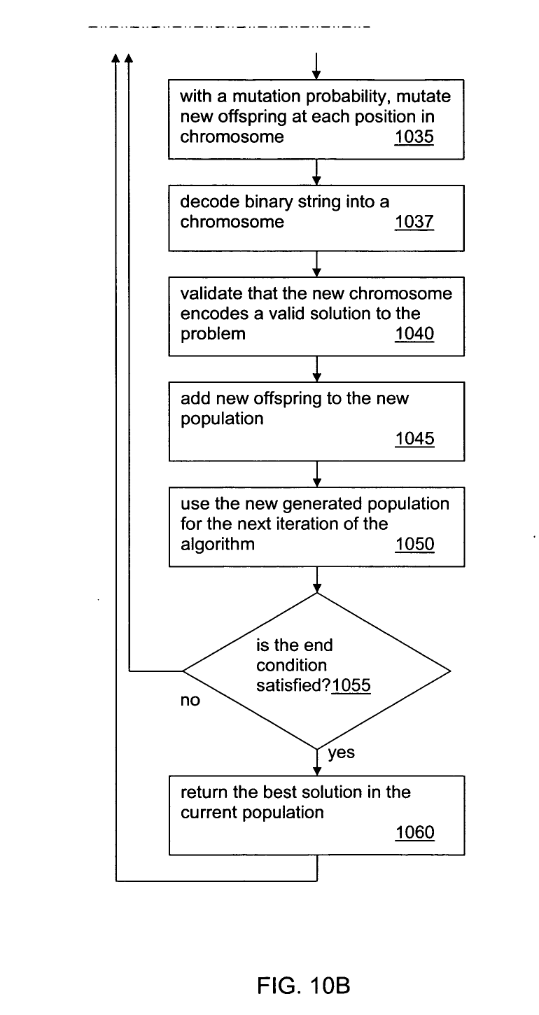

A complete rule gene 501 object interaction is illustrated in the following pseudo-code. The pseudo-code is the logical description of one state of a rule gene 501 occurring during a given GA epoch (step 1010, FIG. 10). The code would be executed within the large predictive model when evaluating the model (step 1015, FIG. 10):

```
    rule_1 = ((var sel 1 >= cat sel 1 AND var sel 1 < cat sel
1) OR (var sel 1 >= cat sel 1 AND var sel 1 < cat sel 1) OR (var
sel 1 >= cat sel 1 AND var sel 1 < cat sel 1) OR (var sel 1 >=
cat sel 1 AND var sel 1 < cat sel 1));
    rule_2 = (var sel 2 IN (cat sel 2));
    result = 0;
    SELECT;
    WHEN (rule_1 AND rule_2) result = coef gene 1;
    WHEN (rule_1) result = coef gene 2;
    WHEN (rule_2) result = coef gene 3;
    OTHERWISE result = coef gene 4;
    END SELECT;
    SCORE = SCORE + result;
    inserting exemplary rule gene 501 component values,
    rule_1 = ((AGE >= 15 AND AGE < 20) OR (AGE >= 21 AND
AGE < 29) OR (AGE >= 30 AND AGE < 45) OR (AGE >= 54 AND
AGE < 60));
    rule_2 = (GENDER IN (M));
    result = 0;
    SELECT;
    WHEN (rule_1 AND rule_2) result = − 0.1281167027802362;
    WHEN (rule_1) result = 0.030701620532853177;
    WHEN (rule_2) result = 0.1683095797601245;
    OTHERWISE result = 0.6549272133548998;
    END SELECT;
    SCORE = SCORE + result.
```

When the above code is applied to an observation (every observation in the dataset), rule_{—}1 is true if the AGE variable has a value that maps to a bit position where the corresponding bit value is 1. Such positions are 15-19 707, 21-28 709, 30-44 711 or 54-59 715. Positions 1-14, 20, 29, 45-53 and 60-100 are not included in the logic statement. Rule_{—}2 is true if the GENDER variable has a value of M 607.

Each coefficient gene 1 517, 2 519, 3 521 and 4 523 contains a predetermined, possible output for the rule gene. Either coefficient gene 1—0.1281167027802362, coefficient gene 2 0.030701620532853177, coefficient gene 3 0.1683095797601245 or coefficient gene 4 0.6549272133548998 is output for the rule gene based on the values of rule_{—}1 and rule_{—}2.

If rule_{—}1 and rule_{—}2 are true, result is set to coefficient gene 1 (−0.1281167027802362). If only rule_{—}1 is true, result is set to coefficient gene 2 (0.030701620532853177). If only rule_{—}2 is true, result is set to coefficient gene 3 (0.1683095797601245). And if neither rule_{—}1 nor rule_{—}2 is true, result is set to coefficient gene 4 (0.6549272133548998).

The above categorical logic replicates a truth table derived from every combination of corresponding variable selection components and category selection components, for example, variable selection component 1—category selection component 1, variable selection component 2—category selection component 2, . . . , variable selection component n—category selection component n, arranged in combinations of true interactions and false interactions. The number of combinations equal the number of coefficient genes employed per (1).

A true interaction is where a variable selection component has a value that is selected by a corresponding category selection component. A false interaction is where a variable selection component has a value that is not selected by a corresponding category selection component. For each variable selection component/category selection component pair, there are two interactions, true and false. Each different combination of true and false interactions, one for each variable selection component/category selection component pair, is logically anded together and results in a different coefficient gene result.

The overall SCORE of the predictive model is incremented by the value of result. The holder variable, result, as defined above is modified based on the above logic. The score variable is defined at the beginning of the entire predictive model and is modified by every active gene group that has an include/exclude gene set to include that gene group.

An include/exclude gene performs binary encoding for feature subset selection. Typically, there is an include/exclude gene associated with every gene group. Include/exclude genes determine which individual variables and interactions encoded in the chromosome should be part of the predictive model. There may be several rule genes in a chromosome, correspondingly several categorical interactions can be present in the predictive model described by the chromosome. This may be accomplished by having include/exclude genes determining if each rule gene should be a part of the predictive model. An include/exclude gene may be evolved like any other gene and during evolution, change the gene group it is part of from being included in the predictive model, to being excluded or the reverse.

In the above example, the rule gene 501 interacts AGE and GENDER variables. Category selection component 1 513 and 2 515 assign the variables.

If the observation has an AGE value within the range specified and a GENDER value of M, the rule gene is predicting that the observation is less likely to be a responder in the predictive model because of the negative value that is returned (coefficient gene 1). A responder is an observation in the dataset with a dependent variable value of 1. However, if the observation has an AGE value outside of the range specified and a GENDER value of F, the rule gene is predicting that the observation is more likely to be a responder in the predictive model because of the positive value that is returned. If the rule gene 501 proves to be able to accurately predict the value of the dependent variable, the greater the value that is returned indicates that the observation will most likely be a responder. If the observation either has an AGE value within the range specified and a GENDER value of M, but not both, the rule gene is predicting the observation has a small likelihood to be a responder in the predictive model because of the small positive values that could be returned.

The variable selection component segment 503 binary string is passed through the evolutionary process and is subject to crossover and mutation as part of the larger chromosome. Due to crossover and mutation, the binary string may change during a subsequent epoch. If during a preceding epoch the value of the first variable selection component 1 509 was 13, it may change to 41 (0000000000101001). After an evolution epoch, a category selection component may be applied to a different variable type. If value 13 was an AGE category, value 41 may be a completely different variable such as INCOME. The rule gene 501 would therefore interact the categories of INCOME with the categories of GENDER assuming the second variable selection component 511 did not change during the subsequent epoch.

An undefined situation may occur during evolution. A variable selection component 503 may return with a value greater than the total number of variables in the modeling dataset. For example, there may be only 30 variables in a dataset, but a variable selection component 503 value after an evolution epoch may become 41. The value would be out of range, attempting to interact the categories of a non-existent variable with the categories of GENDER.

The invention 501 applies modular arithmetic to the variable selection component 503 after an evolution epoch since they may contain an invalid value after mutation. For example, if a variable selection component 503 returned with a value of 41, and there were only 30 variables in a dataset, 41 mod 30=11. The result would be to interact the eleventh variable, for example, the eleventh variable may be EDUCATION_LEVEL. EDUCATION_LEVEL would then interact with GENDER. Applying modular arithmetic does not affect variable selection components that hold valid values. For example, if the total number of variables is 30, 13 mod 30=13.

The category selection component segment 505 binary string is passed through the evolutionary process as part of the larger chromosome. Due to evolution, the binary string may change during a subsequent epoch. If during a preceding epoch category selection component 2 515 selected the second category, Male, it may change to selecting the first category, Female.

The input ranges of category selection component 1 513 are defined by splitting the distance from the median input value to the minimum value into 50 evenly spaced value ranges and by splitting the distance from the median input value to the maximum value into 50 evenly spaced value ranges. Distance splitting is performed for continuous variables used in a rule gene. In the preferred embodiment, the continuous variable is a numeric variable with more than 100 distinct categories. For category selection component 1 513, 0 is the minimum value and 50 is the median for AGE. Each value range has a size of 1 bit determined by subtracting the minimum for the median and dividing by 50. To determine the size of each value range for the median to the maximum value, the median is subtract from the maximum and divided by 50. Each distinct category or value range is represented by one bit in the 100-bit binary string.

The first distinct category or value range is mapped to the first bit position 703, n=0 in the 100-bit binary string 701. The second distinct category or value range is mapped to the second bit in the 100-bit binary string. This process is continued until all distinct categories have been mapped, or all 100 value ranges have been mapped to bits in the binary string. For a distinct category or value range, a bit value 701 of 1 indicates that the category is interacting. A bit value 701 of 0 indicates no interacting. The collections of distinct categories or value ranges that map to bits that are set to 1 create categories that are interacting. This aspect is a method for turning a variable with continuous values into a variable with discrete values.

If in the above example, the second bit position 603 of category selection component 2 515 was a 1 which maps to M, the first bit which maps to F is set to 0 (as shown in FIG. 6). The bit values 601 of the remaining 98 bits 609 are irrelevant because they do not map to a defined category. Even though bit positions 100-3 609 are unused, they may change during evolution.

To encode a binary string from the integer numbers that describes a rule gene 501, the coefficient gene segment 507 comprised of four 64-bit binary strings are concatenated together, followed by the variable selection component segment 503 two 16-bit binary strings. The category selection component segment 505 two 100-bit binary strings are then appended to the end of the rule gene 501.

To decode the binary string after evolution into integer numbers, the four coefficient genes are created using 64-bit groups at the front of the binary string. As each coefficient gene is created, the bits that are used are removed from the string. The next 100 bits are read from the string and used to create a first category selection component. The process is repeated to create a second category selection component out of the following 100 bits. Finally, the next 16 bits are read from the binary string and converted to an integer using the standard binary to decimal conversion to create a first variable selection component, the process is repeated to create a second variable selection component. Decoding is the inverse of the above encoding process.

In the two variable selection component embodiment described above, if both category selection components return true for the input variables, the first coefficient is returned. If only the first category selection component returns true, the second coefficient is returned. If only the second category selection component returns true, the third coefficient is returned. Otherwise the fourth coefficient is returned. This logic may be extended to cases where more than two variables are interacted.

An observation is typically a single row in the dataset, it contains some number of independent variables and a dependent variable. When applying a predictive model against an observation, the greater the score, the more likely that observation is a responder and that the model is predicting the observation to be a responder. When the coefficient gene has a positive value, the equation described above which is part of the large equation of the predictive model is interpreted to mean that observation with a greater age value is more likely to be a responder. The greater the positive value, the stronger this relationship becomes.

When a coefficient gene has a negative value, this equation is interpreted to mean that observation with a greater age value is more likely to be a non-responder, which may also be stated as an observation with a lesser age value is more likely to be a responder. The greater the absolute value of the coefficient gene, the stronger this relationship becomes.

In the exemplary embodiment, the rule gene 501 uses four coefficient genes as the output from a rule logic. While these coefficients are not multiplied by any values, the relationships discussed above hold true. When one of the four rules outputs a positive value, it indicates that its overall score will be incremented, increasing the likelihood that the observation is a responder. The more positive the value, the stronger the likelihood. The inverse is true when the rule outputs a negative value, the overall score will be decremented reducing the likelihood that the observation is a responder.

Only one of the four rules in the example will be true when evaluating an observation in a dataset. Either both category selection components returned true, or the first returned true, or the second returned true, or neither returned true.

Coefficient genes 1 517, 2 519, 3 521 and 4 523 comprise a value and logic that enables the coefficient gene to convert the value between a floating-point number and binary string, and mutate the value by changing random bits in its binary string. The coefficient genes 1 517, 2 519, 3 521, 4 523 obviates statistical estimation methods by embedding a coefficient into a gene. Embedding a coefficient allows the coefficient used in a predictive model to be evolved by a GA rather than needing to use a statistical estimation method. All possible values of a coefficient gene are valid.

FIG. 10 shows a GA method employing the rule gene 501 of the invention. Each chromosome contains the elements of a predictive model that must be evaluated to determine how well that model predicts values for the dependent variable in the dataset referred to as fitness evaluation. A rule gene 501 is converted into part of a predictive model (steps 1005, 1010). Fitness evaluation develops a value for a user specified fitness metric.

The fitness metric selected by the user may be percent correctly classified that can be used with a categorical dependent variable, a linear correlation which can be used with a continuous dependent variable, or an upper lift which is a fitness measure based on only the top quintiles of a generation.

Fitness evaluation applies the chromosome model to each observation in the dataset to determine a predicted value for the dependent variable. Fitness evaluation compares the predicted and actual values for each observation and develops a single fitness metric that represents how well the predicted and actual values match across all observations in the training dataset (step 1015).

After chromosomes in the initial generation have been evaluated and assigned a fitness metric, a genetic algorithm is used in a computer to create the next generation of chromosomes. The genetic algorithm (step 1020) evolution involves the steps of selection (step 1027), crossover (step 1030), and mutation (step 1035) and illustrates the process of the invention to create an initial generation and successive generations. Before evolution, chromosomes (including the rule genes 501) are encoded as a binary string (step 1025).

Selection (step 1027) identifies chromosomes in the initial generation which will be used to create the next generation of chromosomes. The selection of chromosomes is random. Each chromosome in the initial generation is represented by a weighted value that increases the chance of selection in proportion to the fitness metric.

Crossover (step 1030) is to produce candidate chromosomes for the next generation. The parameters which have been selected specify the target number of chromosomes in each generation and a virus rate. The virus rate determines the number of chromosomes (target number times the virus rate) in each generation that are created with a random process. Chromosomes introduced by the virus rate are not the result of selection, crossover, or any consideration of fitness.

A chromosome selected for breeding can be used in one of two ways—cloning or pure (standard) crossover. A crossover rate may be set by the user to control the proportion used for each type of crossover. For example, a 70% crossover rate means 70% of selected chromosomes are used to create offspring through a crossover process and the remaining 30% are used for simple cloning. The cloning process creates a chromosome for the new generation that is a duplicate of a chromosome selected from the current generation.

The crossover process creates two offspring chromosomes for the next generation based on two selected parent chromosomes. The process uses genes from each parent to create each of the offspring chromosomes.

A user controls the crossover process by specifying a number of crossover points, or selecting a uniform crossover process. When one specifies a number of crossover points, the system of the invention places each point at a random location in the chromosome. The crossover points define blocks of genes that are exchanged to create an offspring.

The crossover process creates an offspring by taking genes from one parent up to the first crossover, and taking genes from the other parent between the first and second crossover points. Genes from the first parent are taken between the second and third crossover points. This alternating process can continue for any number of crossover points.

The uniform crossover process uses every possible point in a chromosome as a crossover point. Instead of alternating the use of gene blocks, the system uses a random process to determine if genes from the other parent will be used for the next block. For a chromosome with many genes, crossover (using a gene from the other parent) occurs at half the eligible crossover points.

Crossover points can occur at any point in a variable gene segment. For any variable, a child can have an include/exclude gene from one parent and a coefficient gene from the other parent. The active variables in a child chromosome (created with crossover) must be active in one of the parents but the overall set of active variables will likely be different from either parent.

The chromosomes created by breeding (cloning and crossover) are considered candidates for the next generation and are subjected to mutation. The rule gene is part of a whole chromosome and is converted into a binary string.

Mutation is a random process that reverses selected bits in the candidate chromosomes based on the probability value entered as the mutation rate (step 1035). During mutation, bits are randomly flipped within the chromosomes in order to insure diversity within a generation. After mutation, the binary string is decoded back to chromosome integer values (step 1037) and the mutated rule gene values are validated (step 1040).

As mentioned above, the virus rate determines the number of chromosomes created with a random process. The system uses a random process to create the number of chromosomes that equals the virus rate applied to the desired population size. The remaining chromosomes in the generation are created through crossover. Because the chromosomes introduced by the virus rate are created without regard to fitness measures or any other characteristic of the current generation, they tend to introduce diversity into a new generation that explores new areas of a search space. Increasing the virus rate tends to explore new areas while decreasing the rate tends to fine tune the best models already attained.

After the next generation has been created, each chromosome in the next generation has its fitness evaluated as before (steps 1045, 1050, 1055, 1010, 1015-1060). Following the fitness evaluation, the genetic algorithm is applied to the next generation of chromosomes as discussed above to create a new generation of chromosomes. The iterative process of chromosome creation, evaluation, and next generation chromosome creation continues until the user stops the process.

One or more embodiments of the present invention have been described. Nevertheless, it will be understood that various modifications may be made without departing from the spirit and scope of the invention. Accordingly, other embodiments are within the scope of the following claims.

What is claimed is:

1. A rule gene for use in a chromosome of a genetic algorithm comprising:
at least one variable selection component for determining which variables from a dataset will interact;
at least one category selection component for determining which categories from said dataset will interact; and
at least two coefficient genes, wherein the quantity of variable selection components, category selection components, and coefficient genes that comprise the rule gene is defined as n:n:2ⁿ, respectively, where n≧1, and wherein one of said coefficient genes provides a result from an interaction between said selected variable and said selected category.

2. The rule gene according to claim 1 wherein said variable selection component, category selection component and coefficient genes experience evolution.

3. The rule gene according to claim 2 wherein said variable selection component, said category selection component and said coefficient genes are encoded as binary numbers from integer numbers prior to evolution.

4. The rule gene according to claim 3 wherein each said category selection component is comprised of a plurality of bits, wherein each bit represents a distinct category.

5. The rule gene according to claim 4 wherein each bit of said category selection component represents a value in a range of values for continuous variables.

6. The rule gene according to claim 5 wherein each said coefficient gene holds a predetermined value.

7. The rule gene according to claim 6 wherein said predetermined value is used as a multiplier for another coefficient gene.

8. The rule gene according to claim 6 wherein said predetermined value is an output of another gene.

9. The rule gene according to claim 6 wherein said variable selection component, said category selection component and said coefficient genes are decoded to integer numbers from binary numbers after evolution.

10. The rule gene according to claim 9 wherein modular arithmetic is applied to said variable selection component after evolution to validate that the evolved value is within a predetermined range of variable values.

11. The rule gene according to claim 10 wherein if said category selection component represents a range of variables, the rule gene assembles a logic statement defining each range found within said category selection component.

12. The rule gene according to claim 11 wherein if said category selection component represents distinct categories, each bit represents a distinct category.

13. The rule gene according to claim 12 wherein a true interaction is where a variable selection component has a value that is selected by a corresponding category selection component.

14. The rule gene according to claim 13 wherein a false interaction is where a variable selection component has a value that is not selected by a corresponding category selection component.

15. The rule gene according to claim 14 wherein said result is based on a truth table derived from every combination of corresponding variable selection component and category selection component, arranged in combinations of said true interactions and said false interactions equaling the number of said coefficient genes wherein each different combination of said true interactions and said false interactions is logically anded together and provides a different coefficient gene predetermined value.

16. A method of creating categorical interactions for use in a genetic algorithm as a rule gene comprising:
providing at least one variable selection component for determining which variables from a dataset will interact;
providing at least one category selection component for determining which categories from said dataset will interact; and
providing at least two coefficient genes, wherein the quantity of variable selection components, category selection components, and coefficient genes that comprise the rule gene is defined as n:n:2ⁿ, respectively, where n≧1, and wherein one of said coefficient genes provides a result from an interaction between said selected variable and said selected category.

17. The method according to claim 16 further comprising evolving said variable selection component, category selection component and coefficient genes.

18. The method according to claim 17 further comprising encoding said variable selection component, said category selection component and said coefficient genes as binary numbers from integer numbers prior to evolving.

19. The method according to claim 18 wherein encoding further comprises concatenating said at least two coefficient gene binary numbers with said variable selection component binary number and with said category selection component binary number.

20. The method according to claim 18 wherein each said category selection component is comprised of a plurality of bits, wherein each bit represents a distinct category.

21. The method according to claim 20 wherein each bit of said category selection component represents a value in a range of values for continuous variables.

22. The method according to claim 21 wherein each said coefficient gene holds a predetermined value.

23. The method according to claim 22 wherein said predetermined value is used as a multiplier for another coefficient gene.

24. The method according to claim 22 wherein said predetermined value is an output of another gene.

25. The method according to claim 22 further comprising decoding said variable selection component, said category selection component and said coefficient genes to integer numbers from binary numbers after evolving.

26. The method according to claim 25 further comprising:
creating integer numbers for said coefficient genes from a number of bits corresponding to the number of bits used to form their binary numbers;
creating integer numbers for said category selection component from a number of bits corresponding to the number of bits used to form its binary number; and
creating integer numbers for said variable selection component from a number of bits corresponding to the number of bits used to form its binary number.

27. The method according to claim 25 further comprising applying modular arithmetic to said variable selection component after evolving for validating that the evolved value is within a predetermined range of variable values.

28. The method according to claim 27 further comprising assembling a logic statement for the rule gene defining each range found within said category selection component if said category selection component represents a range of variables.

29. The method according to claim 28 wherein if said category selection component represents distinct categories, each bit represents a distinct category.

30. The method according to claim 29 wherein a true interaction is where a variable selection component has a value that is selected by a corresponding category selection component.

31. The method according to claim 30 wherein a false interaction is where a variable selection component has a value that is not selected by a corresponding category selection component.

32. The method according to claim 31 wherein said result is based on a truth table derived from every combination of corresponding variable selection component and category selection component, arranged in combinations of said true interactions and said false interactions equaling the number of said coefficient genes wherein each different combination of said true interactions and said false interactions is logically anded together and provides a different coefficient gene predetermined value.

33. A method of creating categorical interactions for use in a genetic algorithm as a rule gene comprising:
providing a first and a second variable selection component for determining which variables from a dataset will interact;
providing a first and a second category selection component for determining which categories from said dataset will interact;
providing a first, a second, a third and a fourth coefficient gene, wherein one of said coefficient genes provides a result from an interaction between corresponding selected variables and selected categories further comprising:
choosing said first coefficient gene as said result if a variable selected by said first variable selection component has a value that is selected by said first category selection component and if a variable selected by said second variable selection component has a value that is selected by said second category selection component;
choosing said second coefficient gene as said result if a variable selected by said first variable selection component has a value that is selected by said first category selection component and if a variable selected by said second variable selection component has a value that is not selected by said second category selection component;
choosing said third coefficient gene as said result if a variable selected by said second variable selection component has a value that is selected by said second category selection component and if a variable selected by said first variable selection component has a value that is not selected by said first category selection component; and
choosing said fourth coefficient gene as said result if a variable selected by said first variable selection component has a value that is not selected by said first category selection component, and if a variable selected by said second variable selection component has a value that is not selected by said second category selection component.
